(19) United States
(12) Patent Application Publication
(10) Pub. No.: US 2006/0192508 A1
(43) Pub. Date: Aug. 31, 2006

(54) Electrical drive apparatus having a structure-borne noise sensor

(76) Inventor: Thomas Albers, Minden (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/359,759

(22) Filed: Feb. 23, 2006

(30) Foreign Application Priority Data
Feb. 24, 2005 (DE) 10 2005 008 586.5

(51) Int. Cl. H02K 33/00

(52) U.S. Cl. 318/128

(57) ABSTRACT

A drive apparatus includes an electric motor (9), a control device (2) having a microprocessor (3) and a motor control module (5), which interacts with a power module (7) for the purpose of adjusting desired electrical parameters for the electric motor (9), a connecting line (8), which connects an output of the control device (2) to the electric motor (9), and a self-diagnostics device having a structure-borne noise sensor (6), which is connected to the electric motor, and an assessment module (4) for the signals from said structure-borne noise sensor (6). The invention assessment module is integrated in the control device, to be precise such that the microprocessor (3) of the control device (2) assesses the signals from the structure-borne noise sensor (6). The computational power of the microprocessor used in the operation of the power module (7) is used for directly assessing and interpreting the structure-borne noise signal.

### FIELD OF THE INVENTION

The invention relates to an electrical drive apparatus comprising an electric motor fed by a converter, a control device having a microprocessor and a motor control module, which interacts with a power module for the purpose of adjusting desired electrical parameters for the electric motor, a connecting line, which connects an output of the control device to the electric motor, a self-diagnostics device being provided which has a structure-borne noise sensor, which is arranged on the electric motor, and an assessment module for signals from said structure-borne noise sensor.

### BACKGROUND OF THE INVENTION

Electrical drive apparatuses enjoy success as low-maintenance and powerful drives having an increasing popularity. Thanks to modern semiconductor components, completely controllable drives can also be used for high power classes. The advantages of the electric motor as regards simple design, reliability, freedom from maintenance and controllability therefore open it up to an ever greater number of application areas. In order to further increase the reliability of electrical drive apparatuses and in order to extend maintenance intervals, in recent times structure-borne noise analysis has been used in electric motors. Suitable sensors are used to detect structure-borne noise produced by the movement, generally rotation, of the electric motor, and a suitable assessment device is used to evaluate the occurrence of abnormal signal components indicating a defect. Diagnosis of the drive apparatus can thus take place.

The assessment devices are generally implemented using microprocessor technology. For assessment purposes, characteristic variables such as a root-mean-square value etc. are usually calculated, or else Fourier analysis is carried out. Furthermore, advanced signal processing can be provided which filters out the components relevant for monitoring the state of the electric motor from the diverse signal mixture picked up by the structure-borne noise sensor and evaluates them. Even if acceptable results can still be achieved even from faulty signals which are measured under difficult conditions by the structure-borne noise sensor, thanks to the high standard of microprocessor technology and signal processing, it has been shown that, in the event of a favorable arrangement of the structure-borne noise sensor as close as possible to the critical parts of the electric motor, an improvement in the signal quality can be brought about. Particularly suitable points, however, are often poorly accessible and require the electric motor to be disassembled to a considerable extent from time to time. In practice, the structure-borne noise sensors are therefore often arranged on the outside of the electric motor or the apparatus driven by it. Although this is less complex, the signal quality is often unsatisfactory.

The invention is based on the object of reducing this disadvantage.

### SUMMARY OF THE INVENTION

The solution according to the invention consists in a drive apparatus having the features of claim 1. Advantageous developments are the subject matter of the dependent claims. According to the invention, in the case of an electrical drive apparatus comprising an electric motor, a control device having a microprocessor and a motor control module, which interacts with a power module for the purpose of adjusting desired electrical parameters for the electric motor, a connecting line, which connects an output of the control device to the electric motor, and a self-diagnostics device, which has a structure-borne noise sensor, which is arranged on the electric motor, and an assessment module for the signals from said structure-borne noise sensor, provision is made for the assessment module to be integrated in the control device and to be designed such that the microprocessor of the control module assesses the signals from the structure-borne noise sensor.

The term control device is used below irrespective of whether feedback is provided. It includes both open-loop control systems and closed-loop control systems. Correspondingly, control will be understood in the text which follows to mean open-loop control or closed-loop control.

Converter will be understood to mean a device comprising a motor control module and a power module for the purpose of supplying the electric motor with generally polyphase alternating current from an electrical power source (usually a power supply system). The term includes both unregulated converters (frequency converters) and regulated converters (servo converters).

Microprocessor will be understood to mean an arithmetic logic computation unit designed to process a program. In addition to conventional microprocessors, the term also includes, in particular, microcontrollers, digital signal processors DSP, field programmable gate arrays FPGAs and application-specific integrated circuits ASICs.

The invention is based on the concept that, in the case of contemporary electrical drive apparatuses fed by converters, the control device generally has a powerful microprocessor in order to drive the power module in accordance with the requirements even in the case of high rotation speeds and thus to ensure precise operation of the drive apparatus. The invention has recognized that this microprocessor, which is provided in any case, can also be used for assessing the signals from the structure-borne noise sensor. The invention therefore envisages using the resource “microprocessor” of the control device for the assessment module as well. A separate microprocessor for the assessment module is thus superfluous. The additional complexity for production, programming and incorporating a further microprocessor in the electrical drive apparatus is thus reduced. In addition, the integration according to the invention results in advantages in terms of spatial requirement. A separate microprocessor would require additional space, i.e. a larger or additional housing. Since, according to the invention, a second microprocessor can be avoided, the emitted heat brought about by its power loss is also lost. The thermal load is thus reduced. Analysis of structure-borne noise signals is thus made possible for electrical drive apparatuses without substantial additional costs arising and without additional requirements for physical space or heat dissipation being set. This makes it possible to use the structure-borne noise analysis system even in cost-sensitive sectors and for small drive apparatuses such as servo drives, in the case of which a low physical size is of particular importance. The integration of the assessment in the same microprocessor, which also carries out the control of the power module of the drive apparatus, also makes it possible to incorporate results from the structure-borne noise assessment in the control of the electric motor, and vice versa. This may result in additional synergistic effects.

An output device is expediently provided for the assessed structure-borne noise signals. It is thus possible for an indication to be given to the user as to the result of the assessment of the structure-borne noise signals. The user is thus always informed of the technical status of the drive apparatus. Furthermore, the output device can advantageously be used to transmit signals to a superordinate master control device, such as a programmable logic controller (PLC).

The control device preferably also has an evaluation module, which is designed to evaluate the structure-borne noise signals output by the assessment module. The evaluation module makes it possible to classify whether the operation of the electrical drive apparatus is still possible to the full extent, whether functional restrictions should already take place or whether the operation should be cancelled completely for safety reasons. Furthermore, self-diagnostics can be carried out in order to obtain information on a possible cause of a fault. The evaluation module is therefore expediently provided with pattern characteristics for typically occurring fault situations in a memory, which pattern characteristics are used as the basis for a comparison by means of a classification device. In a corresponding manner, limit values may also be input.

The structure-borne noise sensor can in principle be arranged on the electric motor or on the machine driven by it, as previously. Owing to the integral incorporation of its assessment in the control device, however, it is possible for the structure-borne noise sensor to be fitted at another point. It has been shown that a favorable arrangement is provided within a terminal box of the electric motor. The terminal box is generally mounted directly on the motor, with the result that the structure-borne noise sensor arranged in the terminal box fuses functionally with the electric motor to form one unit. Furthermore, the structure-borne noise sensor is arranged in the terminal box such that it is protected, with the result that defects owing to contamination and/or damage do not occur or only occur to a reduced extent.

Logic means are expediently provided which are designed to transmit measured variables and/or state variables for the converter drive module to the assessment module. Variables and parameters such as the motor currents and the motor rotation speed, which are provided in any case in the motor control module for actual motor control purposes, can thus be transmitted to the assessment module. This assessment module is thus able to also take into account these parameters when assessing the signals from the structure-borne noise sensor. It is thus possible, for example also taking into account the stator currents of the electric motor, to decide whether certain noises only occur when the electric motor is subjected to a load or whether they tend to occur during no-load operation or even when the electric motor is overrunning. The logic means can advantageously have time windows. This means that assessment of the signal from the structure-borne noise sensor is restricted to the time intervals in which the motor is running. This is particularly advantageous when averaging filters (for example moving-average filters) are used in order to avoid falsification of the average value owing to standstill times. Furthermore, this makes it possible for faults owing to cross-couplings between the operation of the motor, on the one hand, and the measurement of the structure-borne noise signals, on the other hand, to be detected easily and filtered out. For this purpose, common-mode rejection means are advantageously provided. They cause faults in the structure-borne noise signal which are brought about by the driving of the electric motor to be reduced. This results in a further improvement in the signal quality from the structure-borne noise sensor and thus ultimately also in an improved assessment result.

The integration of the assessment module in the microprocessor of the control device, which is provided in any case, also has the advantage that the wiring can likewise be designed in an integrated manner. Integrated will in this case be understood to mean that the signal line, which connects the structure-borne noise sensor to the assessment module, is integrated in the connecting line carrying the motor current. Signal line will in this case be understood to mean not only the line carrying the actual measurement signal but also feed lines which may be required for the operation of the structure-borne noise sensor. The connecting line is in any case necessary in order that hardly any notable additional outlay is required for wiring the structure-borne noise sensor.

The cost-saving integration of the assessment module in the microprocessor of the control device according to the invention makes it possible to provide the electrical drive apparatuses with the structure-borne noise analysis system without any notable additional outlay and in a mass-produced manner. Complex retrofitting is thus dispensed with. The mass-production method also has the advantage that the structure-borne noise sensor can be mounted as early as when the electric motor is produced. It is thus possible to arrange it at points which could not be reached or could only be reached with an unreasonably high degree of complexity when retrofitting. The determination of the mounting position of the structure-borne noise sensor can thus merely take place on the basis of the quality of the measurement signals to be expected, without accessibility needing to be taken into account when retrofitting. The structure-borne noise sensor can be arranged on inner elements of the electric motor without any difficulty. An arrangement of the structure-borne noise sensor at bearing points is preferred. A further preferred mounting location is on a force-imparting shaft of the electric motor. It is particularly preferred for the structure-borne noise sensor to be arranged so as to concomitantly rotate with the shaft and for a transmitter to be provided for the purpose of transmitting signals to the assessment module. It has been shown that defects usually occur on rotating components of the electric motor. By means of transmitters, the signals from the structure-borne noise sensor can be transmitted from the rotating shaft to the stationary part. The path for the arrangement of the structure-borne noise sensor on the shaft is first smoothed by the invention since this location is usually suitable for retrofitting. The reason for this is not necessarily the problematic accessibility of the shaft, but consists in the fact that, when retrofitting, there may be problems relating to imbalance which, based on experience, can only be reliably brought under control with difficulty. Since, thanks to the invention, the electrical drive apparatuses can be provided with the structure-borne noise analysis system with little outlay and in a mass-produced manner, the attachment of the sensor can be taken into consideration as early as at the design stage such that no problems relating to imbalance result, such as when retrofitting. Taking into consideration the attachment of the structure-borne noise sensor as early as the design stage also makes it easier to arrange the structure-borne noise sensor such that it is not negatively influenced by the centrifugal force occurring on rotation of the shaft. The structure-borne noise sensor is thus prevented from being overloaded in the event of a rapidly rotating shaft. For this purpose, the structure-borne noise sensor is preferably arranged such that its measurement direction is aligned coaxially with respect to the shaft.

The electric motor does not necessarily need to be in the form of a rotation motor. It may likewise be a linear motor, in particular in an embodiment for oscillating movement.

### DESCRIPTION OF THE DRAWINGS

The invention will be explained below with reference to the drawing, in which an advantageous exemplary embodiment is illustrated and in which:

FIG. 1 shows a schematic overview illustration of an exemplary embodiment of the drive apparatus according to the invention; and

FIG. 2 shows an enlarged detail of a region of the electric motor with examples of arrangement of structure-borne noise sensors.

### DETAILED DESCRIPTION

A drive apparatus according to the invention comprises, as the main modules, an electric motor 9 and a control device 2. The electric motor 9 is connected to a power supply system 70. The control device 2 is connected to a master control device 1 via a dataline 21, for example a fieldbus. The master control device 1 is, for example, a programmable logic controller (PLC) having a terminal for inputting and outputting data with visualization.

The control device 2 has two main components. One of these is the motor control module 5 for driving the electric motor 9 by means of a power module 7. The other is a self-diagnostics device, which essentially comprises an assessment module 4 for signals from a structure-borne noise sensor 6. The assessment module 4 and the motor control module 5 are not implemented independently of one another in the control device 2, but use a common microprocessor 3. The microprocessor 3 is a microprocessor, which is known per se from the prior art, for digital signal processing. It interacts with a random-access memory (RAM) and a read-only memory (ROM), which are not illustrated for reasons of clarity. Furthermore, the microprocessor 3 is connected to an input/output device 22 and a preamplifier filter 48 as well as to optional analog-to-digital converters 55, 57. The design of the microprocessor is known per se and therefore does not need to be described in any more detail. The mentioned components, with which the microprocessor interacts, can be implemented separately or completely or partially in common with the microprocessor on a chip. The operation in connection with the motor control module 5 and the assessment module 4 will be explained in the text which follows.

The electric motor 9 is driven via a converter in accordance with adjustable parameters, as are transmitted in particular by the master control device 1. The converter is formed by the motor control module 5 as the control unit and a power module 7 as the power unit. The electric motor 9 is a servo drive which, thanks to the converter drive module 5 and the power module 7, is completely controllable in terms of rotation speed, torque and rotation direction. Input parameters, for example for motor rotation speed and direction, are applied to the motor control module 5 by the master control device. The motor control module 5 calculates drive signals for the power module 7 from these input parameters using a method known per se, in particular field-oriented regulation. The power module 7 is preferably in the form of a pulse-width-modulated inverter having active switches (e.g. GTOs or IGBTs) which can be switched off. In the exemplary embodiment, the power module 7 is a standard inverter having a DC intermediate circuit (an intermediate circuit is not absolutely necessary, however). On the basis of the signals transmitted by the motor control module 5 via the control line 27, the power module 7 converts the electrical power supplied via the power supply system 70 into a three-phase current with variable frequency and amplitude. This three-phase current is applied to stator windings of the electric motor 9 via a terminal box 98. The three-phase current applied to an electric motor 9 via the connecting lines 8 and the terminal box 98 flows through the stator windings and thus induces a magnetic rotating field in the electric motor 9. Owing to electromagnetic coupling, a torque is thus exerted on the rotor. The rotor and thus the motor shaft 90, on which the rotor is arranged, are caused to carry out a rotary movement.

In order to improve the control performance, current measuring devices 58 are arranged on the three phases of the connecting line 8. They are connected to the analog-to-digital converter 57. Measured values for the actually flowing stator currents of the electric motor 9 are thus applied to the motor control module 5. With the feedback which is thus induced, improved open-loop or closed-loop control of the power module 7 can take place. A rotary transducer 56 is expediently arranged on the electric motor 9. It determines the angular position of the rotor shaft 90. Its signals are applied to a second analog-to-digital converter 55. With the assessment of the signals from the rotary transducer 56, it is possible to achieve a further improvement in the control. In particular, this makes it possible to precisely approach specific positions and thus to use the electric motor 9 as a servo drive.

The structure-borne noise sensor 6 is arranged on the electric motor 9. This arrangement is favorable for good signal quality, but it is still possible for the structure-borne noise sensor to be arranged on the driven unit. It is connected to the preamplifier filter 48 via a signal line 64. This preamplifier filter 48 is designed to amplify signals measured by the structure-borne noise sensor 6 and to filter out undesired components. An operating voltage which may be required is applied to the structure-borne noise sensor 6 via the signal line by means of supply lines (not illustrated). In one preferred embodiment, power supply takes place via a phantom feed system; the number of additional lines is thus minimized. The amplified and filtered signal is applied to the assessment module 4. The assessment module is designed to assess signals from the structure-borne noise sensor 6 by means of methods known per se. The thus assessed signals are applied to the input/output unit 22 of the control device 2 for the purpose of being displayed on the master control device 1 via an output device 44. Furthermore, the assessment module 4 comprises an evaluation module 42. This is designed to carry out classification of the signals measured by the structure-borne noise sensor 6 using criteria which can be preset. It is thus possible to identify whether the measured signals represent fault-free or faulty operation of the electric motor 9. The classification can take place using various predeterminable fault patterns. It is thus possible for different fault patterns to be provided for defects in one of the main bearings, instances of the rotor brushing up against the stator, damage to the housing or its fixing, vibrations etc. The evaluation module is designed to transmit a specific output signal to the output device 44 depending on the pattern detected. Furthermore, it may be designed to immediately bring operation of the electric motor 9 to a halt.

In addition, a logic module 45 is provided which is connected both to the assessment module 4 and the motor control module 5. It is designed to bring about data interchange between the two modules. Provision may thus be made, for example, for an emergency-off signal to be transmitted to the motor control module 5 in the event of a critical fault being detected by the evaluation module 46. This motor control module 5 stops operation of the electric motor 9 without delay in order to prevent further damage. However, data flow may also be provided in the opposite direction. For example, in particular the assessment module 4 can be supplied with signals with respect to the rotation speed, the stator current, the torque and the acceleration of the electric motor 9. Using these data, the assessment of the measured structure-borne noise signal can be improved further. It is thus possible, for example, to establish whether there are any dependencies in relation to specific states. Signals from the structure-borne noise sensor 6, which occur when the motor accelerates when subjected to a load, can thus be differentiated from those which occur during no-load operation or during braking operation of the motor. The quality of the assessment by the assessment module 46 can thus be markedly increased.

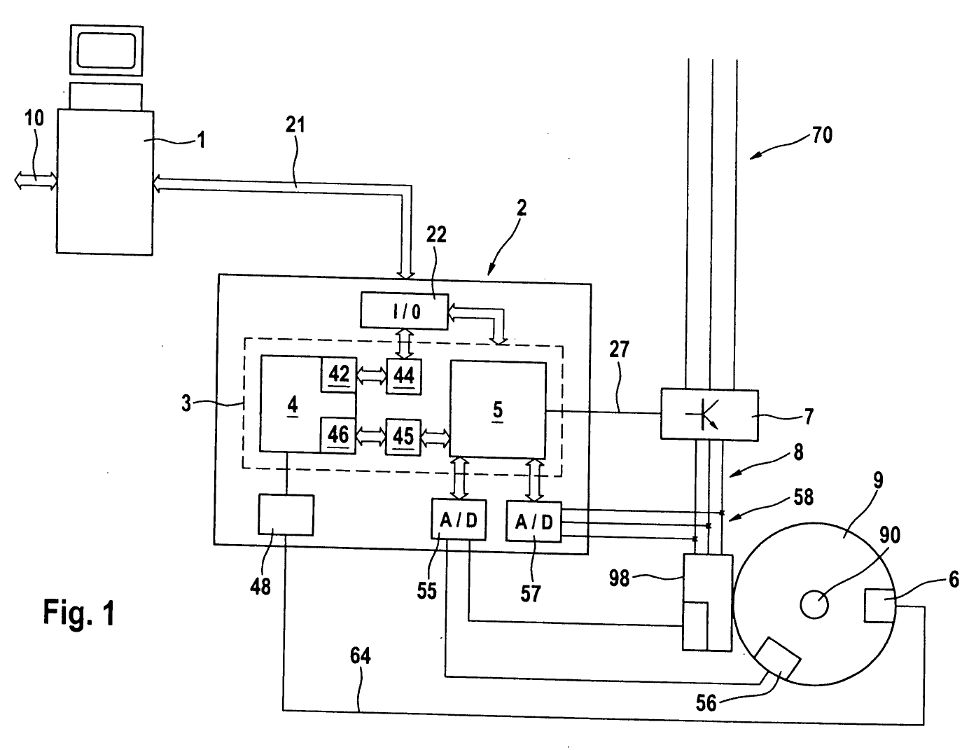

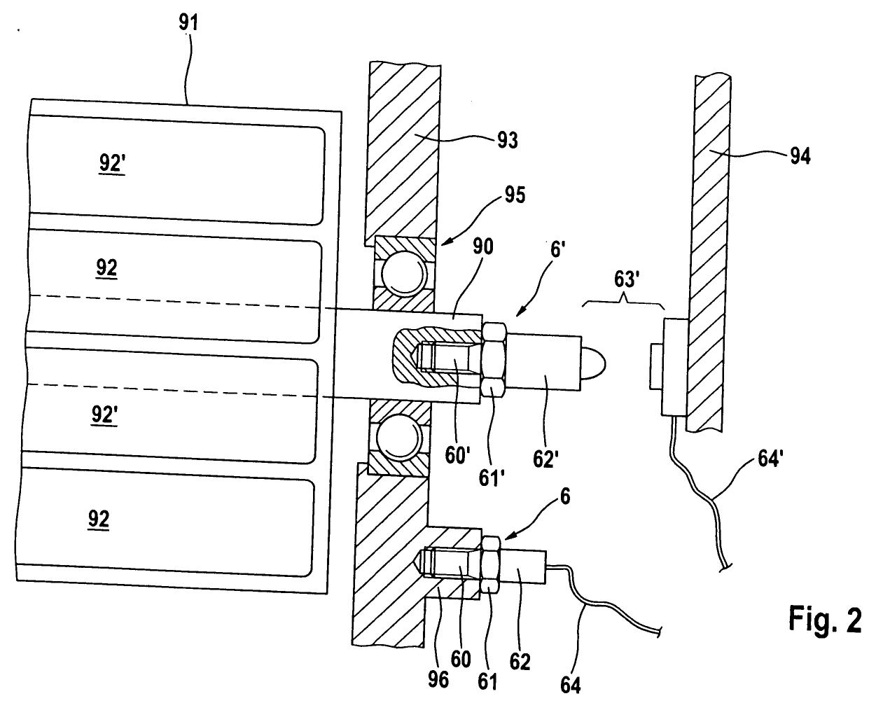

The structure-borne noise sensor 6 can be arranged on the electric motor in various ways. FIG. 2 illustrates two different possibilities by way of example. The figure illustrates, at the bottom, an arrangement of the structure-borne noise sensor 6 which is fixed to the housing and, at the top, an alternative arrangement of the structure-borne noise sensor 6′ on the rotor shaft 90 such that it concomitantly rotates. Before entering into further details in this regard, the design of the electric motor 9 in this area of interest will be explained briefly. While FIG. 1 illustrates a front view of the electric motor 9, FIG. 2 illustrates a partial view of the rear region, in section. Illustrated in the center of this figure is a bearing block 93 which is fixed to the housing and into which a rear rotor bearing 95 is pressed. The rotor bearing 95 is in the form of a conventional ballbearing. Provided behind the bearing block 93 (to the right of said bearing block in FIG. 2) is a rear bearing plate 94, which forms the housing rear wall of the electric motor 9. The rotor 91 is mounted such that it can rotate by means of its shaft 90 via the ballbearing 95. In the exemplary embodiment illustrated, the rotor 91 is in the form of a permanent magnet rotor. It has a plurality of permanent magnets 92, 92′, which are distributed over its circumference and are inserted with alternating polarity. In a magnetic field induced by the stator windings (not illustrated), they cause a torque to form which acts on the rotor 91 and thus cause a rotation of the rotor shaft 90, which is in the form of a force-imparting shaft at the front end side of the housing (cf. FIG. 1).

A receptacle for the structure-borne noise sensor 6 is provided in the lower region of the bearing block 93 on a previously provided attachment. The receptacle is preferably in the form of a threaded blind hole. The structure-borne noise sensor 6 is screwed into this threaded blind hole with a front head piece 60. The head piece 60 has a preferred measuring direction in which its sensitivity is at its greatest. It is oriented such that the preferred measurement direction points in the axial direction of the rotor shaft 90. The sensor 6 has a collar 61 on its center part, which collar 61 acts as a stop and is provided on its outer side with a hexagon for the purpose of making it easier to assemble/disassemble. In its rear region, the structure-borne noise sensor 6 has a measured value pickup 62, which converts the oscillations picked up by the head piece 60 into electrical signals. The electrical signals are passed on to the preamplification filter 48 (cf. FIG. 1) via a connection line 64. With this arrangement close to the bearing, the structure-borne noise sensor can easily detect defects in particular in the region of the bearing 95. Owing to the fact that it is arranged such that it is fixed to the housing, it can also easily detect damaging vibrations of the housing of the electric motor 9.

An alternative arrangement of the structure-borne noise sensor 6′ envisages arranging it on the rear end of the rotor shaft 90. For this purpose, a threaded blind hole is arranged in its rear end face. The structure-borne noise sensor 6′ is screwed into this threaded blind hole with its head piece 60′. A collar 61′ is likewise provided as a stop and for the purpose of simplifying assembly/disassembly. The measurement pickup 62′ arranged in the rear region is also provided at its rear end with one part of an optoelectronic transmitter 63′. The transmitter comprises a transmission device, which is in the form of a directional antenna element arranged on the rear side of the measurement pickup 62′. Concomitantly rotating induction coils (not illustrated) are provided for power supply purposes. Electrical power can thus be obtained from the leakage flux when the rotor shaft 90 rotates. Aligned with the rotor shaft 90, a reception device of the transmitter 63′ is arranged on the inner side of the bearing plate 94 such that it faces the directional antenna element. This reception device is in the form of a demodulator having an integrated amplification circuit. A connection line 64′ is connected to the amplification circuit, and the signals are transmitted to the preamplification filter 48 via said connection line 64′. The operation of the transmission device 63′ is based on a frequency-modulated transmission. The oscillation signals picked up by the structure-borne noise sensor 6′ are provided as switching pulses to the directional antenna element of the transmission device 63′ by means of suitable carrier frequency modulation using a modulator (not illustrated). The radio signals emitted in a corresponding manner by the directional antenna element are picked up by the demodulator of the reception device, amplified by the amplifier circuit and demodulated and then transmitted to the assessment module 4 as a signal in the baseband via the connecting line 64′.

1. An electrical drive apparatus comprising:
an electric motor;
a control device having a microprocessor and a motor control module which interacts with a power module for the purpose of adjusting desired electrical parameters for the electric motor;
a connecting line which connects an output of the control device to the electric motor;
a self diagnostics device which has a structure borne noise sensor which is connected to the electric motor; and
an assessment module for the signals from said structure-borne noise sensor wherein the assessment module is integrated in the control device and is designed such that the microprocessor of the control device assesses the signals from the structure borne noise sensor.

2. The electrical drive apparatus as claimed in claim 1, further comprising an output device for outputting the assessed structure borne noise signals.

3. The electrical drive apparatus as claimed in claim 1, wherein the control device has an evaluation module which is designed to evaluate the structure borne noise signals output by the assessment module.

4. The electrical drive apparatus as claimed in claim 1 further comprising logic means designed to transmit measured variables and/or state variables for the converter drive module to the assessment module.

5. The electrical drive apparatus as claimed in claim 4, wherein the logic means are provided with time windows.

6. The electrical drive apparatus as claimed in claim 1 further comprising common mode rejection means for the assessment module which reduce faults in the structure borne noise signal which are brought about by the driving of the electric motor.

7. The electrical drive apparatus as claimed in claim 1, wherein a signal line which connects the structure borne noise sensor to the assessment module is integrated in the connecting line.

8. The electrical drive apparatus as claimed in claim 1, wherein the structure borne noise sensor is arranged in a terminal box of the electric motor.

9. The electrical drive apparatus as claimed in claim 1 further comprising at least one further structure borne noise sensor.

10. The electrical drive apparatus as claimed in claim 1, wherein the structure borne noise sensor is arranged at bearing points of the electric motor.

11. The electrical drive apparatus as claimed in claim 1, wherein at least one the structure borne noise sensor is arranged on a force-imparting shaft of the electric motor.

12. The electrical drive apparatus as claimed in claim 11, wherein the structure borne noise sensor is arranged so as to concomitantly rotate with the shaft, and a transmitter is provided for the purpose of transmitting signals to the assessment module.

13. The electrical drive apparatus as claimed in claim 12, wherein the transmitter functions in a contactless manner.

14. The electrical drive apparatus as claimed in claim 12, wherein the transmitter comprises a wireless transmission means.

15. The electrical drive apparatus as claimed in claim 12, wherein the transmitter comprises an optocoupler.

16. The electrical drive apparatus as claimed in claim 13 wherein the transmitter comprises an optocoupler.
